(19) United States
(12) Patent Application Publication
(10) Pub. No.: US 2006/0285746 A1
(43) Pub. Date: Dec. 21, 2006

(54) Computer assisted document analysis

(76) Inventors: Sherif Yacoub, Barcelona (ES); Giuliano Di Vitantonio, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/155,191

(22) Filed: Jun. 17, 2005

(51) Int. Cl. G06K 9/34; G06F 17/00

(52) U.S. Cl. 382/176; 715/500; 715/531

(57) ABSTRACT

A method, apparatus, and system are disclosed for computer assisted document analysis. One embodiment is a method for software execution. The method includes selecting, in response to user input, criteria in a character recognition engine to identify suspect errors in scanned documents; executing the engine on a subset of the scanned documents to determine an accuracy of error detection using the criteria; and adjusting, in response to user input, the criteria to adjust the accuracy of identifying suspect errors.

### BACKGROUND

Publishers, government offices, and other institutions often desire to convert large collections of paper-based documents into digital forms that are suitable for digital libraries and other electronic archival purposes. In some instances, the number of documents to be converted is quite large and exceeds thousands or even hundreds of thousands of individual pages.

Computers are used to convert such large collections of paper-based documents into computer-readable formats. For example, paper-based documents are initially scanned to produce digital high-resolution images for each page. The images are further processed to enhance quality, remove unwanted artifacts, and analyze the digital images.

The digital images, however, often include errors and thus are not acceptable for digital libraries and other electronic archival purposes. Even fully automated document analysis and extraction systems are not able to generate documents that are errorless, especially when large collections of paper-based documents are being converted into digital form. By way of example, some documents contain a mixture of text and images, such as newspapers and magazines that include advertisements or pictures. Automated document analysis and extraction systems can generate errors while analyzing and extracting different portions of the documents.

### BRIEF DESCRIPTION OF THE DRAWINGS

FIG. 1 illustrates an exemplary system in accordance with an embodiment of the present invention.

FIG. 2 illustrates an exemplary flow diagram in accordance with an embodiment of the present invention.

FIG. 3 illustrates an exemplary flow diagram of the computer assisted and manual text correction phase in accordance with an embodiment of the present invention.

FIG. 4 illustrates an exemplary text correction tool for performing the computer assisted and manual text correction phase in accordance with an embodiment of the present invention.

### DETAILED DESCRIPTION

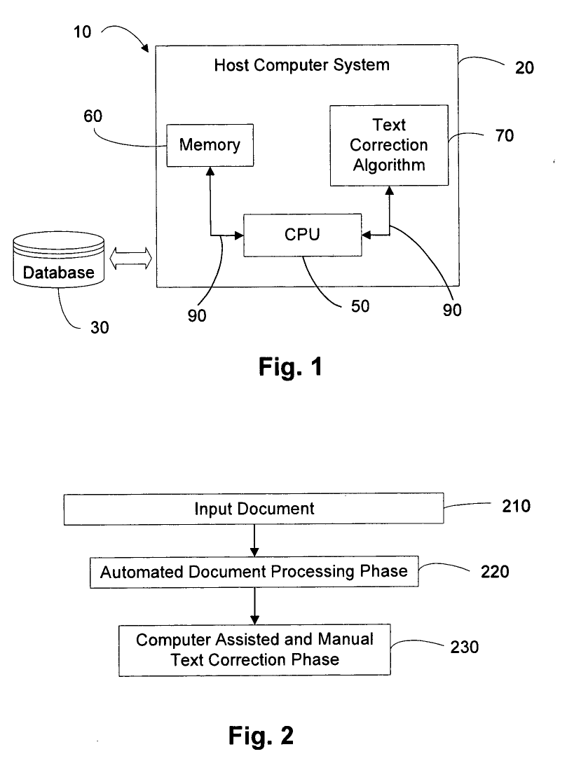

Exemplary embodiments in accordance with the present invention are directed to systems, methods, and apparatus for computer assisted and manual correction of text extracted from documents. These embodiments are utilized with various systems and apparatus. FIG. 1 illustrates an exemplary embodiment as a system 10 for correcting text and articles extracted from documents.

The system 10 includes a host computer system 20 and a repository, warehouse, or database 30. The host computer system 20 comprises a processing unit 50 (such as one or more processors of central processing units, CPUs) for controlling the overall operation of memory 60 (such as random access memory (RAM) for temporary data storage and read only memory (ROM) for permanent data storage) and a text correction engine or algorithm 70. The memory 60, for example, stores data, control programs, and other data associate with the host computer system 20. In some embodiments, the memory 60 stores the text correction algorithm 70. The processing unit 50 communicates with memory 60, data base 30, text correction algorithm 70, and many other components via buses 90.

Embodiments in accordance with the present invention are not limited to any particular type or number of data bases and/or host computer systems. The host computer system, for example, includes various portable and non-portable computers and/or electronic devices. Exemplary host computer systems include, but are not limited to, computers (portable and non-portable), servers, main frame computers, distributed computing devices, laptops, and other electronic devices and systems whether such devices and systems are portable or non-portable.

Reference is now made to FIGS. 2-4 wherein exemplary embodiments in accordance with the present invention are discussed in more detail. In order to facilitate a more detailed discussion of exemplary embodiments, certain terms and nomenclature are explained.

As used herein, the term “document” means a writing or image that conveys information, such as a physical material substance (example, paper) that includes writing using markings or symbols. The term “article” means a distinct image or distinct section of a writing or stipulation, portion, or contents in a document. A document can contain a single article or multiple articles. Documents and articles can be based in any medium of expression and include, but are not limited to, magazines, newspapers, books, published and non-published writings, pictures, text, etc. Documents and articles can be a single page or span many pages and contain characters. The term “character” means a symbol (example, letter, number, image, sign, etc.) that represents information.

As used herein, the term “file” has broad application and includes electronic articles and documents (example, files produced or edited from a software application), collection of related data, and/or sequence of related information (such as a sequence of electronic bits) stored in a computer. In one exemplary embodiment, files are created with software applications and include a particular file format (i.e., way information is encoded for storage) and a file name. Embodiments in accordance with the present invention include numerous different types of files such as, but not limited to, image and text files (a file that holds text or graphics, such as ASCII files: American Standard Code for Information Interchange; HTML files: Hyper Text Markup Language; PDF files: Portable Document Format; and Postscript files; TIFF: Tagged Image File Format; JPEG/JPG: Joint Photographic Experts Group; GIF: Graphics Interchange Format; etc.), etc.

As used herein, an “engine” refers to any software-based algorithm or service that provides a solution to a problem or a field of related problems. An engine is a program or group of programs that includes both systems software (i.e., operating systems and/or utility programs that manage computer resources at a low level) and applications software (i.e., end-user programs or programs that require operating systems and system utilities to run.). For example, an engine is configured for processing data related to optical character recognition (OCR).

FIG. 2 illustrates an exemplary flow diagram for achieving high accuracy in reconstructing articles from documents and correcting text in articles and documents. The flow diagram utilizes two separate phases: a fully automated document processing phase 220, and a computer assisted manual text correction phase 230. In some exemplary embodiments, output from the automated document processing phase is input to the computer assisted manual text correction phase to enable viewing and correcting of text in articles and documents. The viewing and correcting, performed by a user, enable large volumes of documents (example, thousands or millions of pages) to be processed and corrected so documents are accurately converted to digital images with little or no errors. Further, the time and effort to correct errors or make other modifications resulting from the automated document processing phase are significantly reduced since viewing and correcting occur in the computer assisted manual text correction phase.

According to block 210, a document or documents are input. By way of example, the documents include a large collection of paper-based documents that are being converted into digital forms suitable for electronic archival purposes, such as digital libraries or other forms of digital storage. In one exemplary embodiment in accordance with the invention, paper-based documents are scanned and converted into raster electronic versions (example, digital high-resolution images). Raster images for each page of a document (example, TIFF, JPEG, etc.) are further processed with image analysis techniques to enhance image quality and remove unwanted artifacts.

According to block 220, the automated document processing phase occurs on the documents that are input. In this phase, one or more automated processes occur, such as automatic recognition processes to extract the structure and content of the document and/or articles. These processes include, but are not limited to, identification of zones in the document, text recognition (such as OCR: optical character recognition), identification of text reading order in the document, structure analysis, logical and semantic analysis, extraction of articles and advertisements from the documents, etc. By way of further example for this phase, articles in a scanned document are automatically identified with minimal or no user intervention; paper documents are converted into electronic articles or files; multiple scoring schemes are utilized to identify a reading order in an article; and text regions (including title text regions) are stitched to correlate each region of the article. In one exemplary embodiment, this phase includes one or more OCR engines, such as a single OCR engine or multiple OCR engines in a document analysis and understanding system.

Embodiments in accordance with the present invention are compatible with a variety of automated document processing systems, engines, and phases. By way of example, this processing phase is described in United States patent application entitled “Article Extraction” and having application Ser. No. 10/964,094 filed Oct. 13, 2004; this patent application being incorporated herein by reference.

Output from the automated document processing phase 220 can include errors. The computer assisted manual text correction phase enables a user to analyze and modify the output from the automated document processing phase. For example, in order to reduce or eliminate the errors, the computer assisted manual text correction phase occurs according to phase 230. Modifications in phase 230, however, are not limited to correcting errors. As further examples, a user can modify a level of accuracy for text correction or OCR, enable a trade-off between resources and costs during document analysis, etc.

In one exemplary embodiment, human beings (i.e., users) perform the computer assisted manual text correction phase to reduce or eliminate errors from the automated document processing phase. By way of example, a customer can require or specify a particular level of error or accuracy for the extraction of articles from original paper-based documents and their reconstruction as standalone entities. In order to achieve this level of accuracy, both phases 220 and 230 are utilized. In one exemplary embodiment, the automated phase 220 provides automatic digitization and reconstruction of documents with the highest possible automated accuracy, and the computer assisted manual text correction phase provides the human operator with the computer-based tool to manually make additional text corrections where necessary.

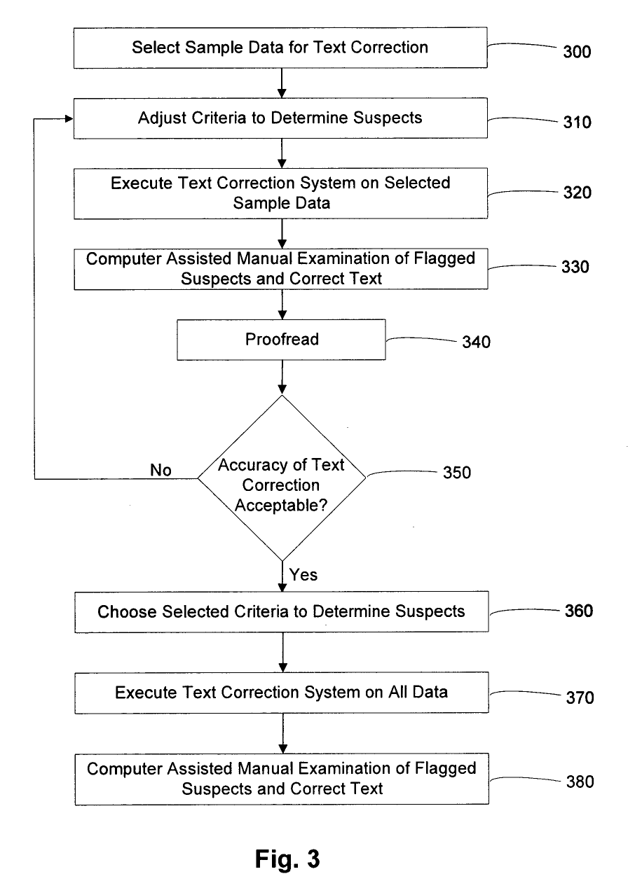

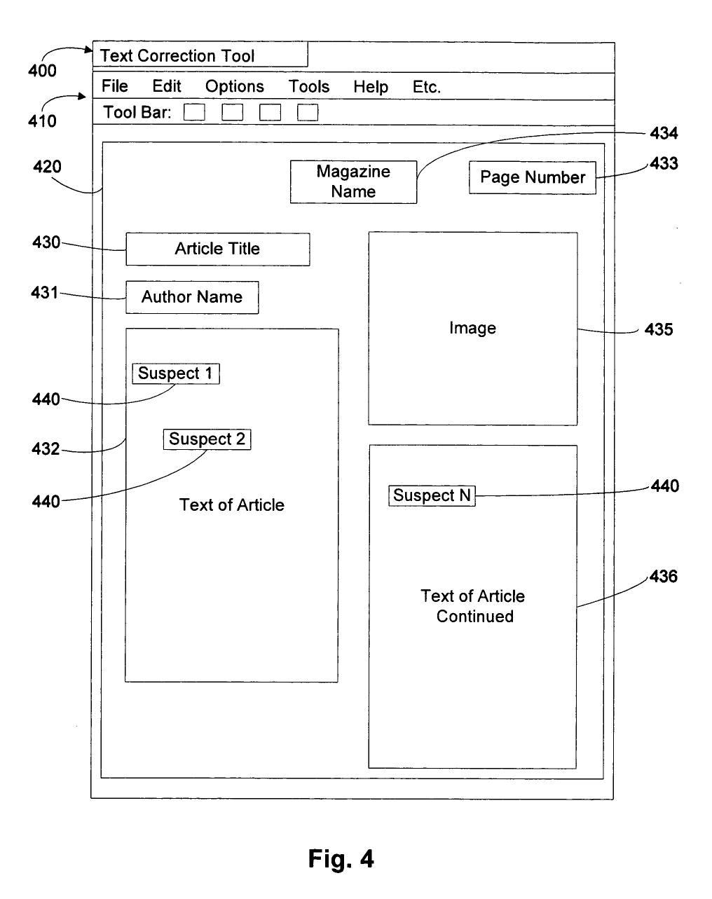

FIG. 3 illustrates an exemplary flow diagram of the computer assisted and manual text correction phase 230 of FIG. 2 in accordance with an embodiment of the present invention. The diagram illustrates plural phases or steps (shown as blocks) that are implemented by a user during the computer assisted and manual text correction phase.

The text correction phase occurs, for example, once the phases needed for automated article structure correction are completed. During the text correction phase, a user verifies and corrects errors (letters, numbers, words, sentences, etc.) that were missed or undiscovered in the automated phase 220. The text correction phase includes modifying characters and comparing the characters or words flagged as suspect to the original text which the tool shows, for example, right at the text under examination. During text correction and verification, a user identifies suspect or erroneous text and corrects the text.

In one exemplary embodiment, the text correction phase includes an optical character recognition (OCR) engine. OCR generally involves reading text from paper-based documents and translating the images into file form (example, ASCII codes or Unicode) so a computer can edit the file with software (example, word processor). By way of example, the OCR engine identifies suspect text with errors by using a confidence level during automated text recognition. Words are marked as suspect due to graphical recognition of the word itself as well as the context in which it is used (grammar, dictionary, etc.) When the confidence in a decision made by the OCR engine is below a certain threshold, the candidate words are flagged as a suspect. Additional suspects are isolated through the utilization of spell checkers and semantic analyzers during or after the processing phase.

According to block 300, a sample data set is selected for text correction. In one exemplary embodiment, the sample data is a subset of a larger data set that will be processed through the text correction system.

By way of example, the data includes page-level or article-level text. A sample data set is used as a representation of the output population. In one exemplary embodiment, the sample dataset represents or includes the various varieties of content types in the larger data set. For example, the larger data set can include thousands or millions of pages having numerous different styles, formats, fonts, resolutions, etc. For instance, different styles can have different recognition accuracy. For example, text over images is harder to recognize than text over white background. In one exemplary embodiment, a sample data set is selected to cover all or many of the different characters of text present in the larger data set.

According to block 310, criteria are adjusted, modified, and/or tuned to determine how suspects and/or errors are determined or calculated. In this process, the input sample data set is processed against a set of suspect flagging criteria. The suspect flagging criteria include, but are not limited to, one or more of the following and/or variations of at least the following:
(1) Confidence score of OCR recognition based on image content is beyond a threshold.
(2) Confidence score of OCR recognition based on context (previous and next words) is beyond a threshold.
(3) A word does not appear in a dictionary.
(4) Multiple OCR engines are used and plural engines do not agree.
(5) Words that are split between two lines are flagged as suspects.
(6) Words that have punctuations attached to them are flagged as suspects.
(7) All punctuations are suspect.

In one exemplary embodiment, criteria are selected from input from or in response to a user. Accuracy of text correction is, thus, controllable and variable from user input and from corresponding selection of the criteria. Users can control or determine a trade-off between increasing the accuracy of output text and increasing the cost associated with reaching that level of accuracy.

According to block 320, the text correction system is executed on the selected sample data with the selected criteria. The output from this phase is the input sample data with word/characters flagged as suspects.

According to block 330, computer assisted manual examination of flagged suspects occurs, and text correction is performed. By way of example, a text correction tool is used to correct the suspect words. Preferably, the text correction tool supports additions, deletions, and/or modifications of criteria (example, those noted herein) to flag suspects. In other words, the text correction tool is adjusted, modified, or tuned to improve or vary the accuracy with which errors and/or suspects are identified in articles and documents.

According to block 340, the manually corrected sample data is proofread. For example, the sample data is verified against the original paper-based document from which the scans or input were created. Differences between the original paper-based document and output from the text correction tool exist as undiscovered text errors. The text errors are marked or noted, and a measure of the final accuracy is obtained. By way of example, text accuracy measures the number of words or characters in the final output that match those words or characters in the original document (example, paper-based article). This measure of text accuracy for the sample date reflects or predicts the level of accuracy for the larger data set.

Generally, automated re-construction of articles contains text errors, so a measure of text accuracy is performed. One method to measure text accuracy is manually proofreading the output against the original document or article and counting the number of characters (or words) that are misspelled or otherwise incorrect. In some exemplary embodiments, proofreading all articles is unviable. Instead, statistical techniques are utilized to estimate how many articles have to be sampled to measure accuracy with a certain degree of precision. Statistical techniques are also used to measure the potential accuracy to tune the number of suspects to be checked during manual correction.

For the purpose of benchmarking the quality of the automated processing, intermediate text accuracy is measured prior to manual correction as well as the final accuracy. Such measurements are performed with proofreading, but the measurements can also be calculated or inferred more rapidly by automatically calculating how many errors have been corrected manually (which is a parameter known to the system). Assuming that all corrections are right, the number of errors at the end of automated processing is the sum of the number of corrected errors plus the number of errors still present in the final output.

According to block 350, a question is asked: Is the accuracy of the computer assisted manual text correction acceptable? In other words, is the measure or level of final accuracy acceptable according to the predetermined or specified accuracy criteria for the larger data set? If the answer to this question is “no,” then the process loops back to block 310 wherein criteria are again adjusted to determine suspects. Here, re-adjustments can occur as new criteria or new combinations of criteria are selected. Thus, if the potential accuracy is not obtained, the criteria for flagging suspects are changed. For example, more or different suspects are flagged in order to increase the likelihood of capturing the residual errors. The process then repeats through blocks 320-350. The loop repeats until a specified accuracy is reached. If the answer to this question is “yes,” then the process proceeds to block 360.

At block 360, the criteria generating the acceptable text correction outcome are selected. Thus, if the desired measure of accuracy is achieved on the sample data set, then the larger or whole data set is processed using the currently selected criteria, as shown in block 370.

According to block 370, the text correction system is executed on the larger data set with the selected criteria. The output from this phase is the input data with word/characters flagged as suspects.

According to block 380, computer assisted manual examination of flagged suspects occurs, and text correction is performed on the larger data set. By way of example, a text correction tool is used to correct the suspect words. The output from this phase should meet or exceed the predetermined or specified accuracy criteria.

The various phases illustrated in FIG. 3 can be implemented in a variety of different tools and processes to verify and check documents. FIG. 4 illustrates an exemplary tool in accordance with embodiments of the invention.

FIG. 4 illustrates an exemplary screenshot of a computer assisted and manual text correction tool 400. The layout and features of the tool 400 are provided as an exemplary illustration. Thus, by way of example, the tool 400 includes a top menu bar 410 with plural dropdown menus (shown as File, Edit, Options, Tools, Help, etc.) and a toolbar. A central portion of the screen includes a page or an image of a document 420 (example, one page of a magazine) that was input into the computer assisted and manual text correction phase (see 230 of FIG. 2). For illustration purposes, the magazine is segmented into a plurality of different regions, sections, or zones (shown as blocks or boxes 430-436). By way of example, some of the different zones include, but are not limited to, publication date, name of the magazine, section name, text of different articles, an image, an image caption, names of authors for different articles, titles of articles, table of contents, footnotes, header/footer, appendix, index, etc.

The text correction tool 400 enables execution of the phases discussed in FIG. 3. The tool enables a user to visually identify and correct errors and/or suspects 440 occurring in the text of the document 420. In one exemplary embodiment, the errors and/or suspects 440 are identified with visible indicia to distinguish the occurrence of an error and/or suspect from the rest of the document. Numerous techniques exist for distinguishing errors and/suspects 440 from other portions of the document and include, but are not limited to, using highlights, color, changes to character appearance (fonts, bold, italicize, underline, shading, notations, symbols, etc.), boxes, markings, text notations, etc. Further, the location of such indicia or indication of errors and/or suspects can occur at various locations on the document 420, such as on or proximate the actual error and/or suspect.

Embodiments in accordance with the invention enable a user to visually verify correctness of output from automated processes directed to reconstructing and correcting articles and documents. One exemplary embodiment processes paper-based documents (example, scanned magazines, books, etc.) and converts such documents into electronic searchable digital repositories. Further, one exemplary embodiment includes a software application or software correction tool that uses visual indicia (such as color, lines, arrows, boxes, etc.) to assist a user in visually identifying, assessing, and correcting the output from the automated document processing phase 220 of FIG. 2.

The text correction tool and text correction phase enable selective computer-assisted text correction by providing the human operator with additional information in order to catch as many errors as possible while checking a small subset of the entire text. In one exemplary embodiment, “suspects” are used. A suspect is a word (or character) in the output produced by the automated processing software that is more likely than others to be an error, and is therefore flagged for inspection by the manual operator. The role of manual text correction is to compare the suspects with the original text, and confirm the choice made by the automated software or manually overrule or change it, if necessary.

In some exemplary embodiments, the terms “errors” and “suspects” are different. An error is a word (or character) in the output of the processed content that differs from the original content. For example, one can be certain that a word (or character) in the output is an error through manual comparison with the original. By contrast, suspects are those words or characters in the output of the processed content that have a higher likelihood of being an error. Some suspects are indeed errors, while other suspects are not errors.

In one exemplary embodiment, suspects are identified by using one or more criteria discussed in connection with block 310 of FIG. 3. As one example, words are marked as suspect due to graphical recognition of the word itself as well as the context in which the word is used (grammar, dictionary, etc.) When the confidence in a decision made by the OCR engine is below a certain threshold, the candidate word is flagged as a suspect. Additional suspects are isolated through the utilization of spell checkers and semantic analyzers during or after the processing phase. These engines flag words that the OCR engine has a high degree of confidence about but have little meaning, are out of context, or are characters known to be error-prone.

Generally, automated OCR engines fail to obtain 100% accuracy in identifying all errors. For example, not all actual errors are flagged as suspects, and not all suspects turn out to be real errors when manually checked (example, existence of false positives and false negatives). A “residual error rate” measures the number of errors that reside in the final output of the system because such errors were not flagged as suspects and subsequently corrected by the operator. Thus, the residual error rate determines the level of accuracy in the finally extracted and re-constructed articles. The computer assisted manual text correction phase controls or determines the residual error rate and enables a user to adjust criteria to obtain a pre-specified residual error rate in the finally extracted and re-constructed articles.

Since human activity is error-prone, operators can introduce errors in the process as well. For example, operators can miss an error that has been correctly flagged as suspect, or erroneously correct a suspect that was indeed right. The net result is that selective manual correction is faster than a thorough and complete comparison of the entire data set but is also inherently imperfect. Accuracy thus depends on the effectiveness of the rules or criteria to flag suspects, the time budget available to check suspects, and the quality of the operators performing the manual correction.

In one exemplary embodiment, the flow diagrams can be automated, manual, and/or a combination of automated and manual. As used herein, the terms “automated” or “automatically” (and like variations thereof) mean controlled operation of an apparatus, system, and/or process using computers and/or mechanical/electrical devices without the necessity of human intervention, observation, effort and/or decision. The term “manual” means the operation of an apparatus, system, and/or process (even if using computers and/or mechanical/electrical devices) has some human intervention, observation, effort and/or decision.

The flow diagrams in accordance with exemplary embodiments of the present invention are provided as examples and should not be construed to limit other embodiments within the scope of the invention. For instance, the blocks or phases should not be construed as steps that must proceed in a particular order. Additional blocks/phases can be added, some blocks/phases removed, or the order of the blocks/phases altered and still be within the scope of the invention. Further, the text correction phases (such as phases 220 and 230 in FIG. 3) can be implemented as a single engine/system or separate, individual and/or plural engines, systems, processes, tools, etc.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software (whether on the host computer system of FIG. 1, a client computer, or elsewhere) will differ for the various alternative embodiments. The software programming code, for example, is accessed by a processor or processors of the computer or server from long-term storage media of some type, such as a CD-ROM drive or hard drive. The software programming code is embodied or stored on any of a variety of known media (such as computer-readable medium) for use with a data processing system or in any memory device such as semiconductor, magnetic and optical devices, including a disk, hard drive, CD-ROM, ROM, flash memory, etc. The code is distributed on such media, or is distributed to users from the memory or storage of one computer system over a network of some type to other computer systems for use by users of such other systems. Alternatively, the programming code is embodied in the memory, and accessed by the processor using the bus. The techniques and methods for embodying software programming code in memory, on physical media, and/or distributing software code via networks are well known and will not be further discussed herein. Further, various calculations or determinations (such as those discussed in connection with the figures are displayed, for example, on a display) for viewing by a user.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method for software execution, comprising:
selecting, in response to user input, criteria in a character recognition engine to identify suspect errors in scanned documents;
executing the engine on a subset of the scanned documents to determine an accuracy of error detection using the criteria; and
adjusting, in response to user input, the criteria to adjust the accuracy of identifying suspect errors.

2) The method of claim 1 further comprising, executing the engine with the adjusted criteria on the scanned documents.

3) The method of claim 1 further comprising, benchmarking the engine by measuring a quality with which the engine automatically recognizes characters in the scanned documents.

4) The method of claim 1 further comprising, automatically calculating, with a statistical technique, a number of articles in the scanned documents required to be sampled to measure accuracy with a certain degree of precision.

5) The method of claim 1 further comprising, measuring intermediate text accuracy prior to manual correction by automatically calculating a number of errors that occurred in the subset of the scanned documents.

6) The method of claim 1 further comprising, calculating a trade-off between obtaining a level of accuracy of identifying suspect errors and a cost associated with reaching the level of accuracy.

7) The method of claim 1 further comprising, obtaining a level of accuracy of identifying suspect errors that meets an agreed level of service.

8) The method of claim 1 wherein, the criteria include at least one of:
(i) a confidence score of optical character recognition based on image content that is beyond a threshold,
(ii) words that do not appear in a dictionary,
(iii) multiple character recognition engines,
(iv) words that are split between two lines are flagged as suspects, and
(v) words that have punctuation are flagged as suspects.

9) The method of claim 1 further comprising, adjusting a threshold for confidence scoring optical character recognition of text content.

10) The method of claim 1 further comprising:
displaying a page of one of the documents;
manually changing, with a text correction tool, a suspect error that is visually distinguishable in the page from surrounding text.

11) The method of claim 1 further comprising, adjusting a number of character recognition engines used to identify suspect errors in the subset of the scanned documents.

12) The method of claim 1 further comprising, controlling the accuracy of identifying suspect errors by modifying the criteria.

13) The method of claim 1 further comprising, automatically extracting articles from the documents using text flow analysis to generate different zones of text regions prior selecting the criteria in the engine.

14) The method of claim 1 further comprising, adjusting the criteria until the accuracy of identifying suspect errors at least meets a predetermined level of accuracy for correcting text errors in the documents.

15) A method for software execution, comprising:
executing an engine on a subset of data to determine suspect errors with a first level of accuracy;
selecting, in response to user input, a first combination of error detecting criteria for the engine; and
executing the engine with the first combination to determine suspect errors in the data with a second level of accuracy greater than the first level of accuracy.

16) The method of claim 15 further comprising:
selecting, in response to user input, a second combination of error detecting criteria;
executing the engine with the second combination to determine suspect errors in the data with a third level or accuracy greater than the second level of accuracy.

17) The method of claim 15 further comprising, proofreading a text-based version of the subset of data to measure the first level of accuracy.

18) The method of claim 15 further comprising, wherein the error detecting criteria are selected from the group consisting of (1) words having punctuation, (2) words split between two lines of text, and (3) word not in a dictionary.

19) The method of claim 15 further comprising, displaying the suspect errors with visible indicia to distinguish the suspect errors from surrounding text.

20) The method of claim 15 further comprising, calculating a final level of accuracy to determine suspect errors before executing the engine on the data.

21) The method of claim 15 further comprising, adjusting, in response to user input, the error detecting criteria in the first combination in response to a comparison between the second level of accuracy and a threshold level of accuracy.

22) The method of claim 15 further comprising, adjusting the error detecting criteria to alter a level of accuracy with which the engine identifies suspect errors.

23) A computer system, comprising:
means for extracting articles from documents to generate different zones of text regions in the articles;
means for executing an engine on at least one article from the documents to determine an accuracy of identifying suspects in the documents using suspect detection criteria;
means for manually correcting, with assistance of a software tool, suspects visually identified using the suspect detection criteria;
means for adjusting, in response to user input, the suspect detection criteria to improve the accuracy of identifying suspects; and
means for executing the engine with the adjusted suspect detection criteria.

24) The computer system of claim 23 further comprising, means for comparing a number of actual errors in the at least one article with a number of suspects identified in the at least one article to determine the accuracy of identifying suspects.

25) Computer code executable on a computer system, the computer code comprising:
code to extract articles from scanned documents during an automated document processing phase;
code to select, in response to user input, a first combination of suspect detecting criteria for a text correction engine;
code to execute the text correction engine on a subset of the documents to determine suspect errors with the first combination of suspect detecting criteria;
code to display the suspect errors with visible indicia to distinguish the suspect errors from surrounding text;
code to select, in response to user input, a second combination of suspect detecting criteria for the text correction engine; and
code to execute the text correction engine with the second combination of suspect detecting criteria to improve accuracy of identifying suspect errors in the documents.

26) A computer readable medium, comprising:
instructions for selecting, in response to user input, criteria in a character recognition engine to identify suspect errors in scanned documents;
instructions for executing the engine on a subset of the scanned documents to determine an accuracy of error detection using the criteria; and
instructions for adjusting, in response to user input, the criteria to adjust the accuracy of identifying suspect errors.

27) The computer readable medium of claim 26 further comprising, instructions for executing the engine with the adjusted criteria on the scanned documents.

28) The computer readable medium of claim 26 further comprising, instructions for controlling the accuracy of identifying suspect errors by modifying the criteria.

29) The computer readable medium of claim 26 further comprising, instructions for:
displaying a page of one of the documents;
manually changing, with a text correction tool, a suspect error that is visually distinguishable in the page from surrounding text.

30) The computer readable medium of claim 26 further comprising, instructions for adjusting a threshold for confidence scoring optical character recognition of text content.
